(19) United States
(12) Patent Application Publication
(10) Pub. No.: US 2013/0089006 A1
(43) Pub. Date: Apr. 11, 2013

(54) MINIMAL COGNITIVE MODE FOR WIRELESS DISPLAY DEVICES

(71) Applicants: Xiaolong Huang, San Diego, CA (US); Vijayalakshmi R. Raveendran, San Diego, CA (US); Xiaodong Wang, San Diego, CA (US); Fawad Shaukat, San Diego, CA (US)

(72) Inventors: Xiaolong Huang, San Diego, CA (US); Vijayalakshmi R. Raveendran, San Diego, CA (US); Xiaodong Wang, San Diego, CA (US); Fawad Shaukat, San Diego, CA (US)

(73) Assignee: QUALCOMM Incorporated, San Diego, CA (US)

(21) Appl. No.: 13/420,933

(22) Filed: Mar. 15, 2012

Related U.S. Application Data
(60) Provisional application No. 61/543,675, filed on Oct. 5, 2011.

(51) Int. Cl. H04B 7/26

(52) U.S. Cl. CPC H04B 7/26
USPC 370/259

(57) ABSTRACT

This disclosure relates to techniques for enabling a sink device in a Wireless Display (WD) system to control operation of the source device and media data sent from the source device. In one example, a method comprises establishing a communication session between a source device and at least one sink device capable of operating in a Minimal Cognitive (MC) mode, wherein the MC mode includes one or more levels, receiving a signal from the sink device to activate a particular level of the MC mode based on trigger information detected at the sink device, and sending media data to the sink device according to an altered operation of the source device for the particular level of the MC mode.

This application claims the benefit of U.S. Provisional Application No. 61/543,675 entitled “MINIMAL COGNITIVE MODE FOR WIRELESS DISPLAY DEVICES,” filed Oct. 5, 2011, the entire content of which is incorporated herein by reference in its entirety.

### TECHNICAL FIELD

The disclosure relates to transmitting data between a wireless source device and a wireless sink device.

### BACKGROUND

Wireless display (WD) systems include a source device and one or more sink devices. The source device and each of the sink devices may be either mobile devices or wired devices with wireless communication capabilities. As mobile devices, for example, one or more of the source device and the sink devices may comprise mobile telephones, portable computers with wireless communication cards, personal digital assistants (PDAs), portable media players, or other flash memory devices with wireless communication capabilities, including so-called “smart” phones and “smart” pads or tablets, or other types of wireless communication devices. As wired devices, for example, one or more of the source device and the sink devices may comprise televisions, desktop computers, monitors, projectors, and the like, that include wireless communication capabilities.

The source device sends media data, such as audio and/or video data, to one or more of the sink devices participating in a particular communication session. The media data may be played back at both a local display of the source device and at each of the displays of the sink devices. More specifically, each of the participating sink devices renders the received media data on its display and audio equipment. In some cases, a user of a sink device may apply user inputs to the sink device, such as touch inputs and remote control inputs. In the WD system, the user inputs are sent from the sink device to the source device. The source device processes the received user inputs from the sink device and applies the effect of the user inputs on subsequent media data sent to the sink device.

### SUMMARY

In general, this disclosure relates to techniques for enabling a sink device in a Wireless Display (WD) system to control operation of the source device and a type of media data sent from the source device. In some circumstances, media data, such as audio and/or video data, produced for some applications running on the source device may be unwanted at the sink device, e.g., when a user of the sink device is driving motor vehicle. The sink device is often the attention focal point of the communication session, so it is beneficial for the sink device to have some control over the media data it receives from the source device beyond terminating the communication session. The techniques, therefore, provide a Minimal Cognitive (MC) mode mechanism to enable the sink device to signal the source device to modify the operation of the source device and the applications running on the source device.

More specifically, the techniques provide MC mode mechanisms that define different levels of operation of applications running on the source device and user input devices at the sink device in response to predefined trigger information detected from a host system of the sink device. As an example, the host system may comprise a motor vehicle host system and the sink device may comprise a media head unit within a motor vehicle. The predefined trigger information may include environmental conditions, user behavior, or user inputs indicating that the user of the sink device within the host system is performing an activity during which certain types of media data from the source device are unwanted. In response to detecting trigger information, the sink device signals activation of an associated level of the MC mode to the source device to modify the operation of the source device during the user's activity. The operation of the user input devices at the sink device may also be modified based on the activated level of the MC mode.

In one example, a method comprises establishing, with a source device, a connection with at least one sink device, wherein the source device and the sink device support a MC mode that includes one or more levels, receiving, with the source device, a signal from the sink device indicating one of the levels of the MC mode, wherein the indicated level of the MC mode is activated at the sink device based on trigger information detected from a host system of the sink device, activating the indicated level of the MC mode at the source device, and sending media data to the sink device according to a modified operation of the source device for the activated level of the MC mode.

In another example, a method comprises establishing, with a sink device, a connection with a source device, wherein the source device and the sink device support a MC mode that includes one or more levels, activating one of the levels of the MC mode at the sink device based on trigger information detected from a host system of the sink device, sending a signal to the source device indicating the activated level of the MC mode at the sink device, and receiving media data at the sink device according to a modified operation of the source device for the activated level of the MC mode.

In a further example, a source device comprises a memory that stores media data, and a processor configured to establish a connection with at least one sink device, wherein the source device and the sink device support a MC mode that includes one or more levels. The processor of the source device is also configured to receive a signal from the sink device indicating one of the levels of the MC mode, wherein the indicated level of the MC mode is activated at the sink device based on trigger information detected from a host system of the sink device, activate the indicated level of the MC mode at the source device, and send media data to the sink device according to a modified operation of the source device for the activated level of the MC mode.

In another example, a sink device comprises a memory that stores media data, and a processor configured to establish a connection with a source device, wherein the source device and the sink device support a MC mode that includes one or more levels. The processor of the sink device is further configured to activate one of the levels of the MC mode at the sink device based on trigger information detected from a host system of the sink device, send a signal to the source device indicating the activated level of the MC mode at the sink device, and receive media data at the sink device according to a modified operation of the source device for the activated level of the MC mode.

In a further example, a source device comprises means for establishing a connection with at least one sink device, wherein the source device and the sink device support a MC mode that includes one or more levels, means for receiving a signal from the sink device indicating one of the levels of the MC mode, wherein the indicated level of the MC mode is activated at the sink device based on trigger information detected from a host system of the sink device, means for activating the indicated level of the MC mode at the source device, and means for sending media data to the sink device according to a modified operation of the source device for the activated level of the MC mode.

In an additional example, a sink device comprises means for establishing a connection with a source device, wherein the source device and the sink device support a MC mode that includes one or more levels, means for activating one of the levels of the MC mode at the sink device based on trigger information detected from a host system of the sink device, means for sending a signal to the source device indicating the activated level of the MC mode at the sink device, and means for receiving media data at the sink device according to a modified operation of the source device for the activated level of the MC mode.

In another example, a computer-readable medium comprises instructions that when executed in a source device cause a programmable processor to establish a connection with at least one sink device, wherein the source device and the sink device support a MC mode that includes one or more levels, receive a signal from the sink device indicating one of the levels of the MC mode, wherein the indicated level of the MC mode is activated at the sink device based on trigger information detected from a host system of the sink device, activate the indicated level of the MC mode at the source device, and send media data to the sink device according to a modified operation of the source device for the activated level of the MC mode.

In a further example, a computer-readable medium comprises instructions that when executed in a sink device cause a programmable processor to establish a connection with the source device, wherein the source device and the sink device support a MC mode that includes one or more levels, activate one of the levels of the MC mode at the sink device based on trigger information detected from a host system of the sink device, send a signal to the source device indicating the activated level of the MC mode at the sink device, and receive media data from the source device according to a modified operation of the source device for the activated level of the MC mode.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a WD system including a source device and a sink device within a host system capable of supporting a Minimal Cognitive (MC) mode.

FIG. 2 is a block diagram illustrating an example of a source device that may implement techniques of this disclosure.

FIG. 3 is a block diagram illustrating an example of a sink device within a host system that may implement techniques of this disclosure.

FIG. 4 is a block diagram illustrating a transmitter system and a receiver system that may implement techniques of this disclosure.

FIG. 5 is a conceptual diagram illustrating an exemplary message transfer sequence for performing MC mode capability negotiations between a source device and a sink device.

FIG. 6 is a conceptual diagram illustrating an example data packet that may be used for signaling an activated level of the MC mode from a sink device to a source device.

FIG. 7 is a flowchart illustrating an exemplary operation of a source device capable of supporting the MC mode.

FIG. 8 is a flowchart illustrating an exemplary operation of a sink device capable of supporting the MC mode.

### DETAILED DESCRIPTION

The disclosure relates to techniques for enabling a sink device in a Wireless Display (WD) system to control operation of the source device and a type of media data sent from the source device. In some circumstances, media data, such as audio and/or video data, produced for some applications running on the source device may be unwanted at the sink device, e.g., when a user of the sink device is driving. The sink device is often the attention focal point of the communication session, so it is beneficial for the sink device to have some control over the media data it receives from the source device beyond terminating the communication session. The techniques, therefore, provide a Minimal Cognitive (MC) mode mechanism to enable the sink device to signal the source device to modify the operation of the source device and the applications running on the source device.

More specifically, the techniques provide MC mode mechanisms that define different levels of operation of applications running on the source device and user input devices at the sink device in response to predefined trigger information detected from a host system of the sink device. As an example, the host system may comprise a motor vehicle host system and the sink device may comprise a media head unit within a motor vehicle. The predefined trigger information may include environmental conditions, user behavior, or user inputs indicating that the user of the sink device within the host system is performing an activity during which certain types of media data from the source device are unwanted. In response to detecting trigger information, the sink device signals activation of an associated level of the MC mode to the source device to modify the operation of the source device during the user's activity. The operation of the user input devices at the sink device may also be modified based on the activated level of the MC mode.

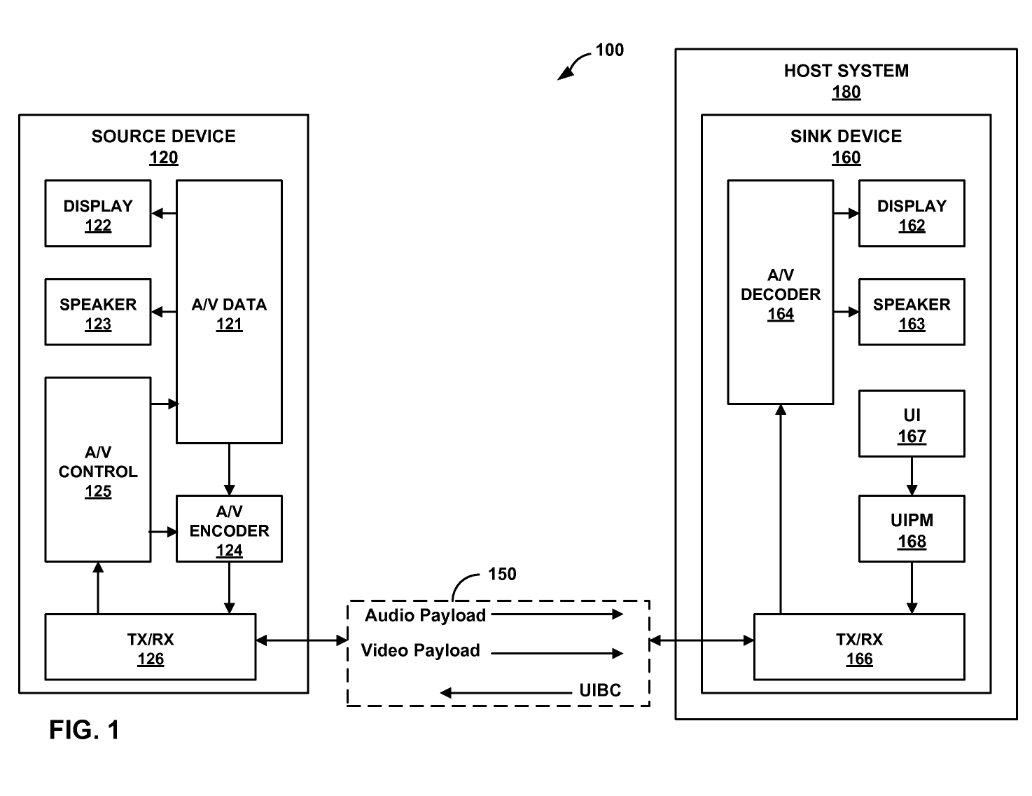

FIG. 1 is a block diagram illustrating an example of a WD system 100 including a source device 120 and a sink device 160 within a host system 180 capable of supporting a Minimal Cognitive (MC) mode. As shown in FIG. 1, WD system 100 includes source device 120 that communicates with sink device 160 via communication channel 150. Host system 180 comprises an environment in which sink device 160 operates.

As an example, host system 180 may comprise a motor vehicle host system that includes sink device 160 as a media head unit including at least a processor and a display within the console of the motor vehicle as an interface between a user of the motor vehicle and host system 180. In this case, source device 120 may comprise a mobile device that provides media data to sink device 160 within host system 180 for display to the user of the motor vehicle. As another example, host system 180 may comprise a conference center host system that includes sink device 160 as a projector, monitor, or television within a conference center. In this case, source device 120 may comprise a mobile device that provides media data to sink device 160 within host system 180 for display to a spectator of a presentation at the conference center.

Source device 120 may include a memory that stores audio and/or video (A/V) data 121, display 122, speaker 123, audio and/or video (A/V) encoder 124 (also referred to as encoder 124), audio and/or video (A/V) control module 125, and transmitter/receiver (TX/RX) unit 126. Sink device 160 may include display 162, speaker 163, audio and/or video (A/V) decoder 164 (also referred to as decoder 164), transmitter/receiver unit 166, user input (UI) device 167, and user input processing module (UIPM) 168. The illustrated components constitute merely one example configuration for WD system 100. Other configurations may include fewer components than those illustrated or may include additional components than those illustrated.

In the example of FIG. 1, source device 120 can display the video portion of A/V data 121 on display 122 and can output the audio portion of A/V data 121 on speaker 123. A/V data 121 may be stored locally on source device 120, accessed from an external storage medium such as a file server, hard drive, external memory, Blu-ray disc, DVD, or other physical storage medium, or may be streamed to source device 120 via a network connection such as the internet. In some instances A/V data 121 may be captured in real-time via a camera and microphone of source device 120. A/V data 121 may include multimedia content such as movies, television shows, or music, but may also include real-time content generated by source device 120. Such real-time content may for example be produced by applications running on source device 120, or video data captured, e.g., as part of a video telephony session. Such real-time content may in some instances include a video frame of user input options available for a user to select. In some instances, A/V data 121 may include video frames that are a combination of different types of content, such as a video frame of a movie or TV program that has user input options overlaid on the frame of video.

In addition to rendering A/V data 121 locally via display 122 and speaker 123, A/V encoder 124 of source device 120 can encode A/V data 121, and transmitter/receiver unit 126 can transmit the encoded data over communication channel 150 to sink device 160. Transmitter/receiver unit 166 of sink device 160 receives the encoded data, and A/V decoder 164 decodes the encoded data and outputs the decoded data via display 162 and speaker 163. In this manner, the audio and video data being rendered by display 122 and speaker 123 can be simultaneously rendered by display 162 and speaker 163. The audio data and video data may be arranged in frames, and the audio frames may be time-synchronized with the video frames when rendered.

A/V encoder 124 and A/V decoder 164 may implement any number of audio and video compression standards, such as the ITU-T H.264 standard, alternatively referred to as MPEG-4, Part 10, Advanced Video Coding (AVC), or the newly emerging high efficiency video coding (HEVC) standard. Many other types of proprietary or standardized compression techniques may also be used. Generally speaking, A/V decoder 164 is configured to perform the reciprocal coding operations of A/V encoder 124. Although not shown in FIG. 1, in some aspects, A/V encoder 124 and A/V decoder 164 may each be integrated with an audio encoder and decoder, and may include appropriate MUX-DEMUX units, or other hardware and software, to handle encoding of both audio and video in a common data stream or separate data streams.

As will be described in more detail below, A/V encoder 124 may also perform other encoding functions in addition to implementing a video compression standard as described above. For example, A/V encoder 124 may add various types of metadata to A/V data 121 prior to A/V data 121 being transmitted to sink device 160. In some instances, A/V data 121 may be stored on or received at source device 120 in an encoded form and thus not require further compression by A/V encoder 124.

Although, FIG. 1 shows communication channel 150 carrying audio payload data and video payload data separately, it is to be understood that in some instances video payload data and audio payload data may be part of a common data stream. If applicable, MUX-DEMUX units may conform to the ITU H.223 multiplexer protocol, or other protocols such as the user datagram protocol (UDP). A/V encoder 124 and A/V decoder 164 each may be implemented as one or more microprocessors, digital signal processors (DSPs), application specific integrated circuits (ASICs), field programmable gate arrays (FPGAs), discrete logic, software, hardware, firmware or any combinations thereof. Each of A/V encoder 124 and A/V decoder 164 may be included in one or more encoders or decoders, either of which may be integrated as part of a combined encoder/decoder (CODEC). Thus, each of source device 120 and sink device 160 may comprise specialized machines configured to execute one or more of the techniques of this disclosure.

Display 122 and display 162 may comprise any of a variety of video output devices such as a cathode ray tube (CRT), a liquid crystal display (LCD), a plasma display, a light emitting diode (LED) display, an organic light emitting diode (OLED) display, or another type of display device. In these or other examples, the displays 122 and 162 may each be emissive displays or transmissive displays. Display 122 and display 162 may also be touch displays such that they are simultaneously both input devices and display devices. Such touch displays may be capacitive, resistive, or other type of touch panel that allows a user to provide user input to the respective device.

Speaker 123 may comprise any of a variety of audio output devices such as headphones, a single-speaker system, a multi-speaker system, or a surround sound system. Additionally, although display 122 and speaker 123 are shown as part of source device 120 and display 162 and speaker 163 are shown as part of sink device 160, source device 120 and sink device 160 may in fact be a system of devices. As one example, display 162 may be a television, speaker 163 may be a surround sound system, and decoder 164 may be part of an external box connected, either wired or wirelessly, to display 162 and speaker 163. In other instances, sink device 160 may be a single device, such as a tablet computer or smartphone. In still other cases, source device 120 and sink device 160 are similar devices, e.g., both being smartphones, tablet computers, or the like. In this case, one device may operate as the source and the other may operate as the sink. These rolls may even be reversed in subsequent communication sessions. In still other cases, the source device may comprise a mobile device, such as a smartphone, laptop or tablet computer, and the sink device may comprise a more stationary device (e.g., with an AC power cord), in which case the source device may deliver audio and video data for presentation to a large crowd via the sink device.

Transmitter/receiver unit 126 and transmitter/receiver unit 166 may each include various mixers, filters, amplifiers and other components designed for signal modulation, as well as one or more antennas and other components designed for transmitting and receiving data. Communication channel 150 generally represents any suitable communication medium, or collection of different communication media, for transmitting video data from source device 120 to sink device 160. Communication channel 150 is usually a relatively short-range communication channel, similar to Wi-Fi, Bluetooth, or the like. However, communication channel 150 is not necessarily limited in this respect, and may comprise any wireless or wired communication medium, such as a radio frequency (RF) spectrum or one or more physical transmission lines, or any combination of wireless and wired media. In other examples, communication channel 150 may even form part of a packet-based network, such as a wired or wireless local area network, a wide-area network, or a global network such as the Internet. Additionally, communication channel 150 may be used by source device 120 and sink device 160 to create a peer-to-peer link.

Source device 120 and sink device 160 may establish a communication session according to a capability negotiation using, for example, Real-Time Streaming Protocol (RTSP) control messages. Source device 120 and sink device 160 may then communicate over communication channel 150 using a communications protocol such as a standard from the IEEE 802.11 family of standards. Source device 120 and sink device 160 may, for example, communicate according to the Wi-Fi Direct (WFD) standard, such that source device 120 and sink device 160 communicate directly with one another without the use of an intermediary such as wireless access points or so called hotspots. Source device 120 and sink device 160 may also establish a tunneled direct link setup (TDLS) to avoid or reduce network congestion. WFD and TDLS are intended to setup relatively short-distance communication sessions. Relatively short distance in this context may refer to, for example, less than approximately 70 meters, although in a noisy or obstructed environment the distance between devices may be even shorter, such as less than approximately 35 meters, or less than approximately 20 meters.

The techniques of this disclosure may at times be described with respect to WFD, but it is contemplated that aspects of these techniques may also be compatible with other communication protocols. By way of example and not limitation, the wireless communication between source device 120 and sink device may utilize orthogonal frequency division multiplexing (OFDM) techniques. A wide variety of other wireless communication techniques may also be used, including but not limited to time division multi access (TDMA), frequency division multi access (FDMA), code division multi access (CDMA), or any combination of OFDM, FDMA, TDMA and/or CDMA.

In addition to decoding and rendering data received from source device 120, sink device 160 can also receive user inputs from user input device 167. User input device 167 may, for example, be a keyboard, mouse, trackball or track pad, touch screen, voice command recognition module, or any other such user input device. UIPM 168 formats user input commands received by user input device 167 into a data packet structure that source device 120 is capable of interpreting. Such data packets are transmitted by transmitter/receiver 166 to source device 120 over communication channel 150. Transmitter/receiver unit 126 receives the data packets, and A/V control module 125 parses the data packets to interpret the user input command that was received by user input device 167. Based on the command received in the data packet, A/V control module 125 can change the content being encoded and transmitted. In this manner, a user of sink device 160 can control the audio payload data and video payload data being transmitted by source device 120 remotely and without directly interacting with source device 120.

Additionally, users of sink device 160 may be able to launch and control applications on source device 120. For example, a user of sink device 160 may able to launch a photo editing application stored on source device 120 and use the application to edit a photo that is stored locally on source device 120. Sink device 160 may present a user with a user experience that looks and feels like the photo is being edited locally on sink device 160 while in fact the photo is being edited on source device 120. Using such a configuration, a device user may be able to leverage the capabilities of one device for use with several devices. For example, source device 120 may comprise a smartphone with a large amount of memory and high-end processing capabilities. When watching a movie, however, the user may wish to watch the movie on a device with a bigger display screen, in which case sink device 160 may be a tablet computer or even larger display device or television. When wanting to send or respond to email, the user may wish to use a device with a physical keyboard, in which case sink device 160 may be a laptop. In both instances, the bulk of the processing may still be performed by source device 120 even though the user is interacting with a sink device. The source device and the sink device may facilitate two way interactions by negotiating and or identifying the capabilities of the devices in any given session.

In some configurations, A/V control module 125 may comprise an operating system process being executed by the operating system of source device 120. In other configurations, however, A/V control module 125 may comprise a software process of an application running on source device 120. In such a configuration, the user input command may be interpreted by the software process, such that a user of sink device 160 is interacting directly with the application running on source device 120, as opposed to the operating system running on source device 120. By interacting directly with an application as opposed to an operating system, a user of sink device 160 may have access to a library of commands that are not native to the operating system of source device 120. Additionally, interacting directly with an application may enable commands to be more easily transmitted and processed by devices running on different platforms.

User inputs applied at sink device 160 may be sent back to source device 120 over communication channel 150. In one example, a reverse channel architecture, also referred to as a user interface back channel (UIBC) may be implemented to enable sink device 160 to transmit the user inputs applied at sink device 160 to source device 120. The reverse channel architecture may include upper layer messages for transporting user inputs, and lower layer frames for negotiating user interface capabilities at sink device 160 and source device 120. The UIBC may reside over the Internet Protocol (IP) transport layer between sink device 160 and source device 120. In this manner, the UIBC may be above the transport layer in the Open System Interconnection (OSI) communication model. To promote reliable transmission and in sequence delivery of data packets containing user input data, UIBC may be configured to run on top of other packet-based communication protocols such as the transmission control protocol/internet protocol (TCP/IP) or the user datagram protocol (UDP). UDP and TCP can operate in parallel in the OSI layer architecture. TCP/IP can enable sink device 160 and source device 120 to implement retransmission techniques in the event of packet loss.

The UIBC may be designed to transport various types of user input data, including cross-platform user input data. For example, source device 120 may run the iOS® operating system, while sink device 160 runs another operating system such as Android® or Windows®. Regardless of platform, UIPM 168 can encapsulate received user input in a form understandable to A/V control module 125. A number of different types of user input formats may be supported by the UIBC so as to allow many different types of source and sink devices to exploit the protocol regardless of whether the source and sink devices operate on different platforms. Generic input formats may be defined, and platform specific input formats may both be supported, thus providing flexibility in the manner in which user input can be communicated between source device 120 and sink device 160 by the UIBC.

According to the techniques of this disclosure, sink device 160 may control operation of source device 120 and/or the applications running on source device 120 to modify the type of media data rendered and transmitted from source device 120. In some circumstances, media data, such as telephone calls, text messages, and other A/V content, produced for some applications running on source device 120 may be unwanted at sink device 160. For example, text messages and other content requiring user interaction may be unwanted when a user of sink device 160 is driving, giving a presentation, or performing some other activity during which distractions would be unwelcome and/or dangerous. Sink device 160 is often the attention focal point of the communication session, so it is beneficial for sink device 160 to have some control over the media data it receives from source device 120 beyond simply terminating the communication session. The techniques, therefore, provide a Minimal Cognitive (MC) mode mechanism to enable sink device 160 to signal source device 120 to modify the operation of source device 120 and the applications running on source device 120.

More specifically, the techniques provide MC mode mechanisms that define one or more levels of operation of the applications running on source device 120 and user input devices at sink device 160 in response to predefined trigger information detected from host system 180. The predefined trigger information may include certain environmental conditions, user behaviors, or user inputs indicating that the user of sink device 160 within the host system is performing an activity during which certain types of media data from source device 120 are unwanted. In some cases, sink device 160 may detect the trigger information from one or more sensors included in host system 180. For example, when host system 180 comprises a motor vehicle host system, the trigger information may include indications of changing lanes, making a turn, bad weather conditions (e.g., rain or snow), other vehicles getting close, or simply driving. As another example, when host system 180 comprises a conference center host system, the trigger information may include indications of dimming the lights, multiple people entering the room, or user input that a presentation is about to begin.

In response to detecting the trigger information, sink device 160 signals activation of an associated level of the MC mode to source device 120. A/V control module 125 in source device 120 then parses the received signal to identify the level of the MC mode activated at sink device 160. A/V control module 125 activates the indicated level of the MC mode at source device 120, and can modify operation of source device 120 and/or applications running on source device 120 to change the type of content being rendered and transmitted to sink device 160 during the user's activity. The activated level of the MC mode may also be used to modify the operation of UI device 167 at sink device 160 to change the type of user interaction allowed during the user's activity.

Each of the one or more levels of the MC mode specify rules according to which operation of source device 120 and/or sink device 160 may be modified. For example, the rules for a given level of the MC mode may cause A/V control module 125 to modify operation of source device 120 and applications running on source device 120 to only render certain types of media data, e.g., telephone calls, text messages, and audio and/or video content. The rules for a given level of the MC mode may also cause modified operation of UI device 167 at sink device 160 to only allow certain types of user interaction with sink device 160, e.g., voice and touch commands, voice commands only, or no commands.

A MC mode capability negotiation may occur between source device 120 and sink device 160 prior to establishing a communication session or at various times throughout a communication session. As part of this negotiation process, source device 120 and sink device 160 may agree to enable the MC mode for the communication session. When the MC mode is enabled, sink device 160 may activate one of the levels of the MC mode based on the trigger information detected from host system 180. Sink device 160 then sends a signal to source device 120 indicating the activated level of the MC mode. Based on the activated level of the MC mode, source device 120 modifies operation of A/V control 125 to only process the types of media data permitted for the activated level of the MC mode. In addition, based on the activated level of the MC mode, sink device 160 modifies operation of UI device 167 to only accept the types of user input permitted for the activated level of the MC mode.

According to the techniques of this disclosure, source device 120 and sink device 160 may perform the MC mode capability negotiation for a communication session using RTSP control messages. If both source device 120 and sink device 160 support the MC mode, source device 120 may enable the MC mode for the communication session. Once the MC mode is enabled for the communication session, sink device 160 signals the activated level of the MC mode to source device 120 over communication channel 150. In some cases, sink device 160 may use the UIBC to signal the activated level of the MC mode to source device 120. In other cases, sink device 160 may use a RTSP control message to indicate the activated level of the MC mode to source device 120.

As an example, host system 180 may comprise a motor vehicle host system that includes sink device 160 as a media head unit within the console of the motor vehicle. Host system 180 may comprise a computer system of the motor vehicle configured to control some portions of the motor vehicle and interface with a user (e.g., driver and/or passengers) of the motor vehicle. The media head unit may include at least a processor and a display and operate as an interface between the user and host system 180. In this case, source device 120 may comprise a mobile device that provides media data to sink device 160 within host system 180 for display to the user of the motor vehicle.

As one example, source device 120 may comprise a smartphone owned by the user of the motor vehicle. While the user is in the motor vehicle, the smartphone (i.e., source device 120) may transmit media data to the media head unit (i.e., sink device 160) of host system 180 embedded within the console of the motor vehicle for display to the user. When the user is driving, it may be undesirable for all types of media data, particularly media data that requires user interaction, to be sent to sink device 160 for display to the driver. The techniques of this disclosure allow sink device 160 to detect trigger information from host system 180 that the motor vehicle is being driven and/or the environmental or traffic conditions in which the driving is taking place, and determine a level of the MC mode associated with the trigger information. Sink device 160 may then signal source device 120 indicating the level of the MC mode in order to modify the type of media data received from source device 120 to only include data that is not distracting or dangerous for the driving conditions.

In another example, host system 180 may comprise a conference center host system that includes sink device 160 as a projector, monitor, or television within a conference center. Host system 180 may comprise a computer system of the conference center configured to control some portions of the conference center and interface with a user (e.g., presenter and/or spectator) of the conference center. In this case, source device 120 may comprise a mobile device that provides media data to sink device 160 within host system 180 for display to one or more spectators during a presentation.

As one example, source device 120 may comprise a smartphone owned by a presenter in the conference center. The smartphone (i.e., source device 120) may transmit media data to the projector, monitor, or television (i.e., sink device 160) of host system 180 within the conference center for display to the spectators. When the user is giving a presentation, it may be undesirable for all types of media data, particularly personal media data, to be sent to sink device 160 for display to all the spectators of the presentation. The techniques of this disclosure allow sink device 160 to detect trigger information from host system 180 that the conference center is filling with an audience and/or a presentation has begun in the conference center, and determine a level of the MC mode associated with the trigger information. Sink device 160 may then signal source device 120 indicating the level of the MC mode in order to modify the type of media data received from source device 120 to only include data that is personal or unrelated to the presentation.

In the example of FIG. 1, source device 120 may comprise a smartphone, tablet computer, laptop computer, desktop computer, Wi-Fi enabled television, or any other device capable of transmitting audio and video data. Sink device 160 within host system 180 may likewise comprise a smartphone, tablet computer, laptop computer, desktop computer, Wi-Fi enabled television, or any other device capable of receiving audio and video data and receiving user input data. In some instances, sink device 160 may include a system of devices, such that display 162, speaker 163, UI device 167, and A/V encoder 164 all parts of separate but interoperative devices. Source device 120 may likewise be a system of devices rather than a single device.

In this disclosure, the term source device is generally used to refer to the device that is transmitting A/V data, and the term sink device is generally used to refer to the device that is receiving the A/V data from the source device. In many cases, source device 120 and sink device 160 may be similar or identical devices, with one device operating as the source and the other operating as the sink. Moreover, these rolls may be reversed in different communication sessions. Thus, a sink device in one communication session may become a source device in a subsequent communication session, or vice versa.

In some examples, WD system 100 may include one or more sink devices within one or more host systems in addition to sink device 160 and host system 180. Similar to sink device 160, the additional sink devices may receive A/V data from source device 120 and transmit user commands to source device 120 over an established UIBC. In some configurations, the multiple sink devices may operate independently of one another, and A/V data output at source device 120 may be simultaneously output at sink device 160 and one or more of the additional sink devices. In alternate configurations, sink device 160 may be a primary sink device and one or more of the additional sink devices may be secondary sink devices. In such an example configuration, sink device 160 and one of the additional sink devices may be coupled, and sink device 160 may display video data while the additional sink device outputs corresponding audio data. Additionally, in some configurations, sink device 160 may output transmitted video data only while the additional sink device outputs transmitted audio data.

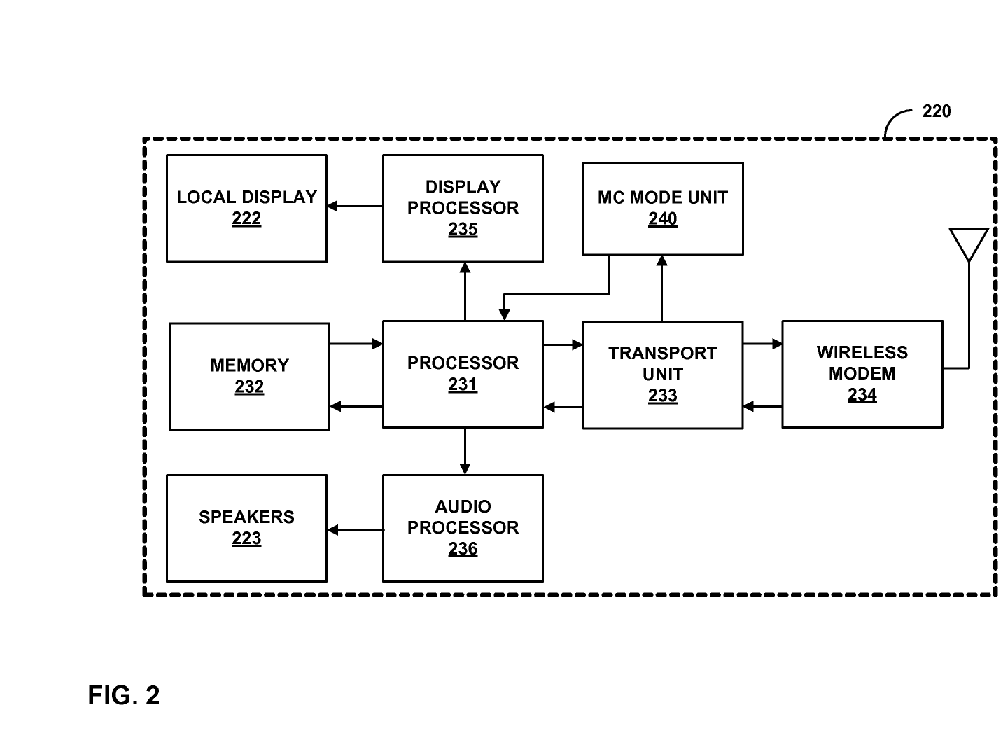

FIG. 2 is a block diagram showing one example of a source device 220. Source device 220 may be a device similar to source device 120 in FIG. 1 and may operate in the same manner as source device 120. Source device 220 includes local display 222, speakers 223, processor 231, display processor 235, audio processor 236, memory 232, transport unit 233, wireless modem 234, and MC mode driver 240. As shown in FIG. 2, source device 220 may include one or more processors (i.e. processor 231, display processor 235 and audio processor 236) that encode and/or decode A/V data for transport, storage, and display. The media or A/V data may for example be stored at memory 232. Memory 232 may store an entire A/V file, or may comprise a smaller buffer that simply stores a portion of an A/V file, e.g., streamed from another device or source.

Transport unit 233 may process encoded A/V data for network transport. For example, encoded A/V data may be processed by processor 231 and encapsulated by transport unit 233 into Network Access Layer (NAL) units for communication across a network. The NAL units may be sent by wireless modem 234 to a wireless sink device via a network connection. Wireless modem 234 may, for example, be a Wi-Fi modem configured to implement one of the IEEE 802.11 family of standards. Source device 220 may also locally process and display A/V data. In particular, display processor 235 may process video data to be displayed on local display 222, and audio processor 236 may process audio data for output on speaker 223.

As described above with reference to source device 120 of FIG. 1, source device 220 may receive user input commands and MC mode level indications from a sink device. For example, wireless modem 234 of source device 220 may receive encapsulated user input data packets, such as NAL units, from a sink device and send the encapsulated data units to transport unit 233 for decapsulation. Transport unit 233 may extract the user input data packets from the NAL units, and processor 231 may parse the data packets to extract the user input commands. Based on the user input commands, processor 231 modifies the type of A/V data being processed by source device 220. In other examples, source device 220 may include a user input unit or driver (not shown in FIG. 2) that receives the user input data packets from transport unit 233, parses the data packets to extract the user input commands, and direct processor 231 to modify the type of A/V data being processed by source device 220 based on the user input commands.

According to the techniques of this disclosure, wireless modem 234 of source device 220 may receive MC mode level indications in either encapsulated data packets or control messages from a sink device. Wireless modem 234 may then send the MC mode data packets or control messages to transport unit 233. As illustrated in FIG. 2, MC mode unit 240 receives the MC mode data packets or control messages from transport unit 233, parses the data packets or control messages to extract the MC mode levels, and direct processor 231 to modify the type of A/V data, e.g., telephone calls, text messages, and audio and/or video content, being processed by source device 220 based on the indicated MC mode levels. Although illustrated in FIG. 2 as a separate unit within source device 220, in other examples MC mode unit 240 may operate within processor 231 to extract the indicated MC mode levels and modify the processing of A/V data. In this manner, the functionality described above in reference to A/V control module 125 of FIG. 1 may be implemented, either fully or partially, by processor 231 and MC mode unit 240.

The MC mode mechanisms described in this disclosure define one or more different levels of operation of source device 220 in response to predefined trigger information detected by a sink device. Each of the one or more levels of the MC mode specifies rules according to which operation of source device 220 may be modified. For example, the rules for a given level of the MC mode may direct modification of processor 231 to only render certain types of media data, e.g., telephone calls, text messages, and audio and/or video content. In some cases, the rules for a given level of the MC mode may also direct modification of a user input interface at the sink device to only allow certain types of user interaction. The number of levels included in the MC mode may be defined according to the WD communication session standard, e.g., WFD or TDLS. As an example, the WFD standard may define three different MC mode levels: MC-1, MC-2, and MC-3. In other examples, the MC mode may define more or fewer levels of operation.

A vender of source device 220 and/or a sink device in communication with source device 220 may be responsible for configuring rules associated with each of the levels. The vendor may also be responsible for assigning trigger information used at the sink device to identify each of the levels. The rules associated with each of the MC mode levels specify the type of media data allowed to be rendered by processor 231 for transmission to the sink device while operating in the particular MC mode. The configured rules for the different levels of the MC mode may be stored in MC mode unit 240 or memory 232. When MC mode unit 240 receives a data packet or control message indicating one of the levels of the MC mode activated at the sink device, MC mode unit 240 modifies the operation of processor 231 to only process the type of A/V data, e.g., telephone calls, text messages, and audio and/or video content, allowed by the rules associated with the activated level of the MC mode.

Table 1, below, illustrates exemplary rules configured for each of three levels of the MC mode, MC-1, MC-2 and MC-3, with respect to the different types of media data rendered by source device 220 and the user input received by the sink device.

TABLE 1

| | Applications | | | |
|---|---|---|---|---|
| | | Text | General AV | User Input |
| MC Level | Telephony | Messaging | at Source | at Sink |
| MC-1 | AV Allowed | Voice | Allowed | Allowed |
| | | command | | |
| | | only | | |
| MC-2 | Voice | No AV | Voice | Voice |
| | command | allowed | command | command |
| | only | | only | only |
| MC-3 | Redirect to | No AV | Not | Not |
| | voice mail | allowed | allowed | allowed |

For example, according to Table 1, at the MC-1 level, the associated rules may allow normal processing and transmission of telephone calls and general A/V content by source device 220, but restrict the operation of processor 231 to only render voice command text messages. At the MC-2 level, the associated rules may restrict the operation of processor 231 to only render voice command telephone calls and voice command A/V content, and to not render any text messages. In addition, the rules associated with the MC-2 level may restrict user interaction at the sink device to be voice command only. At the MC-3 level, the associated rules may restrict the operation of processor 231 to not render any telephone calls, text messages, or general A/V content for transmission to the sink device. In addition, the rules associated with the MC-3 level may not allow any user interaction at the sink device. In other examples, different rules may be configured for one or more of MC mode levels MC-1, MC-2, and MC-3, or for additional MC mode levels.

Processor 231 of FIG. 2 generally represents any of a wide variety of processors, including but not limited to one or more digital signal processors (DSPs), general purpose microprocessors, application specific integrated circuits (ASICs), field programmable logic arrays (FPGAs), other equivalent integrated or discrete logic circuitry, or some combination thereof. Memory 232 of FIG. 2 may comprise any of a wide variety of volatile or non-volatile memory, including but not limited to random access memory (RAM) such as synchronous dynamic random access memory (SDRAM), read-only memory (ROM), non-volatile random access memory (NVRAM), electrically erasable programmable read-only memory (EEPROM), FLASH memory, and the like, Memory 232 may comprise a computer-readable storage medium for storing audio/video data, as well as other kinds of data. Memory 232 may additionally store instructions and program code that are executed by processor 231 as part of performing the various techniques described in this disclosure.

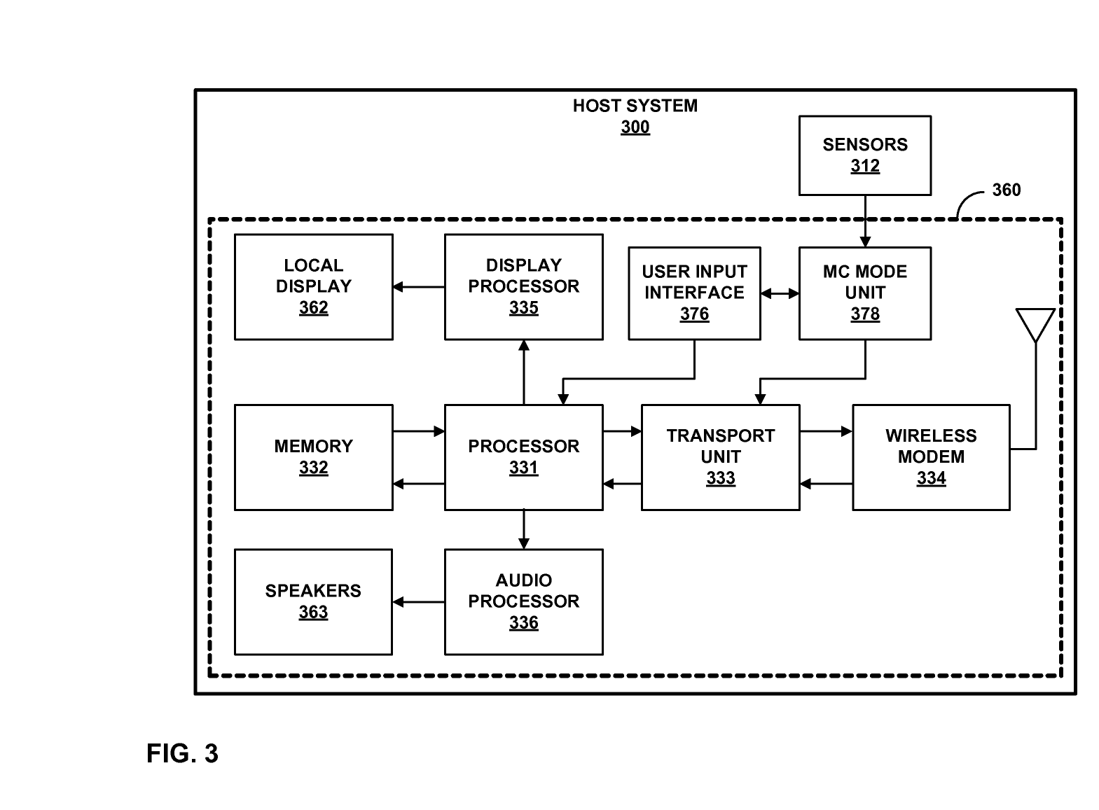

FIG. 3 is a block diagram illustrating an example of a sink device 360 within a host system 300 that may implement techniques of this disclosure. Host system 300 comprises an environment in which sink device 180 operates. For example, host system 300 may comprise a motor vehicle host system that includes sink device 360 as a media head unit embedded within a console of the motor vehicle for display to a user, e.g., driver and passengers, of the motor vehicle. As another example, host system 300 may comprise a conference center host system that includes sink device 360 as a projector, monitor, or television within the conference center for presentation to a user, e.g., presenter and spectators, of the conference center. Host device 300 and sink device 360 may be similar to host device 180 and sink device 160 in FIG. 1.

Sink device 360 includes processor 331, memory 332, transport unit 333, wireless modem 334, display processor 335, local display 362, audio processor 336, speaker 363, user input interface 376, and MC mode unit 378. Sink device 360 receives at wireless modem 334 encapsulated data units sent from a source device. Wireless modem 334 may, for example, be a Wi-Fi modem configured to implement one more standards from the IEEE 802.11 family of standards. Transport unit 333 can decapsulate the encapsulated data units. For instance, transport unit 333 may extract encoded video data from the encapsulated data units and send the encoded A/V data to processor 331 to be decoded and rendered for output. Display processor 335 may process decoded video data to be displayed on local display 362, and audio processor 336 may process decoded audio data for output on speaker 363.

In addition to rendering audio and video data, wireless sink device 360 may also receive user input data through user input interface 376. User input interface 376 can represent any of a number of user input devices included but not limited to a touch display interface, a keyboard, a mouse, a voice command module, gesture capture device (e.g., with camera-based input capturing capabilities) or any other of a number of user input devices. User input received through user input interface 376 can be processed by processor 331. This processing may include generating data packets that include the received user input command. Once generated, transport unit 333 may process the data packets for network transport to a source device over a UIBC.

According to the techniques of this disclosure, sink device 360 may detect trigger information from host system 300. Host system 300 may include one or more sensors 312 capable of sensing environmental conditions, user behavior, and/or user inputs from host system 300. MC mode unit 378 processes the detected trigger information to determine one of the levels of the MC mode associated with the detected trigger information. MC mode unit 378 may then activate the determined level of the MC mode at sink device 360 to modify the type of interaction, e.g., voice and touch commands, voice commands only, or no commands, allowed by a user of the motor vehicle via user input interface 376. Although illustrated in FIG. 3 as a separate unit within sink device 360, in other examples MC mode unit 378 may operate within processor 331 to determine and activate the level of the MC mode based on the detected trigger information.

Upon activating the level of the MC mode, MC mode unit 378 also directs transport unit 333 to generate a signal indicating the activated level of the MC mode and send the signal to a source device. As one example, transport unit 333 may indicate the activated level of the MC mode within a data packet. Transport unit 333 may process the data packet for network transport to the source device over a UIBC. As another example, transport unit 333 may indicate the activated level of the MC mode within a control message, e.g., a RTSP control message, sent to the source device over a communication channel. The source device may then modify the type of A/V data, e.g., telephone calls, text messages, and audio and/or video content, being transmitted to sink device 360 based on the indicated MC mode level.

As one example, host system 300 may comprise a motor vehicle host system that includes sink device 360 as a media head unit within the console of the motor vehicle. In this case, host system 300 may comprise a computer system of the motor vehicle configured to control some portions of the motor vehicle and interaction with a user of the motor vehicle. When host system 300 comprises a motor vehicle host system, the trigger information may include indications of the following: changing lanes, making a turn, bad weather conditions (e.g., rain or snow), other vehicles getting close, or simply driving. In some cases, the trigger information may comprise user input indicating a particular environmental condition or an intended user behavior, e.g., driving, received via one of sensors 312 in host system 300 or via user input interface 376. The trigger information may identify a particular level of the MC mode that defines rules to comply with laws, regulations, or safe driving habits when using a mobile device or other computing device.

As another example, host system 300 may comprise a conference center host system that includes sink device 360 as a projector, monitor, or television within a conference center. In this case, host system 300 may comprise a computer system of the conference center configured to control some portions of the conference center and interface with a user (e.g., presenter and/or spectator) of the conference center. When host system 300 comprises a conference center, the trigger information may include indications of the following: dimming the lights, multiple people entering the room, or user input that a presentation is about to begin. In some cases, the trigger information may comprise user input indicating an intended user behavior, e.g., giving a presentation, received via one of sensors 312 in host system 300 or via user input interface 376. In this case, the trigger information may identify a particular level of the MC mode that defines rules to ensure that all spectators of the presentation do not see personal and unrelated media data, e.g., telephone calls, text messages, or other audio and/or video content, during the presentation.

The MC mode mechanisms described in this disclosure define one or more different levels of operation of sink device 360 in response to predefined trigger information detected from host system 300. Each of the one or more levels of the MC mode specifies rules according to which operation of sink device 360 may be modified. For example, the rules for a given level of the MC mode may determine what types of media data sink device 360 will receive from a source device while operating in the given MC mode level. In addition, the rules for a given level of the MC mode may direct modification of user input interface 376 in sink device 360 to only allow certain types of user interactions, e.g., voice and touch commands, voice commands only, or no commands. As described above with request to source device 220 from FIG. 2, the number of levels included in the MC mode may be defined according to the WD communication session standard, e.g., WFD or TDLS.

A vender of sink device 360 and/or a source device in communication with sink device 360 may be responsible for configuring rules associated with each of the levels. The vendor may also be responsible for assigning trigger information from host system 300 to identify each of the levels. The configured rules and trigger information for the different levels of the MC mode may be stored in MC mode unit 378 or memory 332. The rules associated with each of the MC mode levels specify a type of media data allowed to be rendered by a source device and transmitted to sink device 360, and a type of user interaction allowed at sink device 360 while operating in the particular MC mode level.

When MC mode unit 378 receives trigger information from sensors 312 within host system 300, MC mode unit 378 determines the MC mode level associated with the detected trigger information. MC mode unit 378 may then activate the determined level of the MC mode at sink device 360. Based on the activated MC mode level, MC mode unit 378 modifies the operation of user input interface 376 to only accept the type of user input and interaction, e.g., voice and touch commands, voice commands only, or no commands, allowed by the rules associated with the activated level of the MC mode. In addition, MC mode unit 378 directs transport unit 333 to generate a signal indicating the activated level of the MC mode and send the signal to the source device to modify the type of data rendered and transmitted to sink device 360 while operating in the MC mode level.

With respect to Table 1 above, at the MC-1 level the associated rules may allow sink device 360 to receive telephone calls and general A/V content from the source device, but restrict text messages to voice command only. At the MC-2 level, the associated rules may restrict telephone calls and general A/V content received from the source device to voice command only, and eliminate text messages from the source device. In this case, the rules associated with the MC-2 level may restrict all user interaction at source device 360 via user input interface 376 to be voice command only. At the MC-3 level, the associated rules may eliminate all telephone calls, text messages, and general A/V content received from the source device. In this case, the rules associated with the MC-3 level may not allow any user interaction at sink device 360 via user input interface 376.

As one example where host system 300 comprises a motor vehicle host system, according to the MC mode levels of Table 1, when sink device 360 detects via sensors 312 in host system 300 that a user is driving in good conditions, sink device 360 may signal activation of MC-1 to the source device to only modify operation of a text messaging application at the source device. When sink device 360 detects that a user is driving in poor conditions (e.g., heavy traffic or bad weather), sink device 360 may signal activation of MC-2 or MC-3 to the source device to modify operation of all the media data applications running at the source device, and modify operation of user input interface 376 at sink device 360.

Processor 331 of FIG. 3 may comprise one or more of a wide range of processors, such as one or more digital signal processors (DSPs), general purpose microprocessors, application specific integrated circuits (ASICs), field programmable logic arrays (FPGAs), other equivalent integrated or discrete logic circuitry, or some combination thereof. Memory 332 of FIG. 3 may comprise any of a wide variety of volatile or non-volatile memory, including but not limited to random access memory (RAM) such as synchronous dynamic random access memory (SDRAM), read-only memory (ROM), non-volatile random access memory (NVRAM), electrically erasable programmable read-only memory (EEPROM), FLASH memory, and the like, Memory 232 may comprise a computer-readable storage medium for storing audio/video data, as well as other kinds of data. Memory 332 may additionally store instructions and program code that are executed by processor 331 as part of performing the various techniques described in this disclosure.

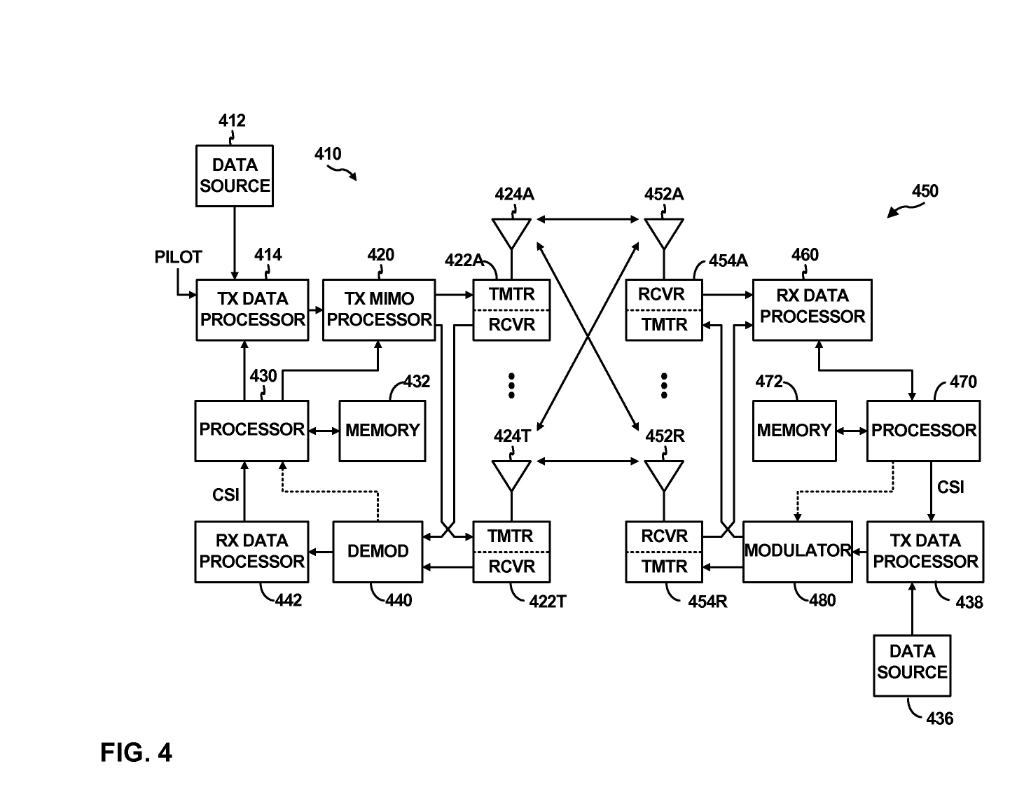

FIG. 4 is a block diagram illustrating an example transmitter system 410 and receiver system 450, which may be used by transmitter/receiver 126 and transmitter/receiver 166 of FIG. 1 for communicating over communication channel 150. At transmitter system 410, traffic data for a number of data streams is provided from a data source 412 to a transmit (TX) data processor 414. Each data stream may be transmitted over a respective transmit antenna. TX data processor 414 formats, codes, and interleaves the traffic data for each data stream based on a particular coding scheme selected for that data stream. The coded data for each data stream may be multiplexed with pilot data using orthogonal frequency division multiplexing (OFDM) techniques. A wide variety of other wireless communication techniques may also be used, including but not limited to time division multi access (TDMA), frequency division multi access (FDMA), code division multi access (CDMA), or any combination of OFDM, FDMA, TDMA and/or CDMA.

Consistent with FIG. 4, the pilot data is typically a known data pattern that is processed in a known manner and may be used at receiver system 450 to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK, or M-QAM (Quadrature Amplitude Modulation), where M may be a power of two) selected for that data stream to provide modulation symbols. The data rate, coding, and modulation for each data stream may be determined by instructions performed by processor 430 which may be coupled with memory 432.

The modulation symbols for the data streams are then provided to a TX MIMO processor 420, which may further process the modulation symbols (e.g., for OFDM). TX MIMO processor 420 can then provide N_{T} modulation symbol streams to N_{T} transmitters (TMTR) 422A-422T (“transmitters 422”). In certain aspects, TX MIMO processor 420 applies beamforming weights to the symbols of the data streams and to the antenna from which the symbol is being transmitted. Each of transmitters 422 may receive and process a respective symbol stream to provide one or more analog signals, and further condition (e.g., amplify, filter, and upconvert) the analog signals to provide a modulated signal suitable for transmission over the MIMO channel. N_{T} modulated signals from transmitters 422 are then transmitted from N_{T} antennas 424A-424t (“antennas 424”), respectively.

At receiver system 450, the transmitted modulated signals are received by N_{R} antennas 452A-452R (“antennas 452”) and the received signal from each of antennas 452 is provided to a respective one of receivers (RCVR) 454A-454R (“receivers 454”). Each of receivers 454 conditions (e.g., filters, amplifies, and downconverts) a respective received signal, digitizes the conditioned signal to provide samples, and further processes the samples to provide a corresponding “received” symbol stream. A receive (RX) data processor 460 then receives and processes the N_{R} received symbol streams from N_{R} receivers 454 based on a particular receiver processing technique to provide N_{T} “detected” symbol streams. The RX data processor 460 then demodulates, deinterleaves and decodes each detected symbol stream to recover the traffic data for the data stream. The processing by RX data processor 460 is complementary to that performed by TX MIMO processor 420 and TX data processor 414 at transmitter system 410.

A processor 470 that may be coupled with a memory 472 periodically determines which pre-coding matrix to use. The reverse link message may comprise various types of information regarding the communication link and/or the received data stream. The reverse link message is then processed by a TX data processor 438, which also receives traffic data for a number of data streams from a data source 436, modulated by a modulator 480, conditioned by transmitters 454, and transmitted back to transmitter system 410.

At transmitter system 410, the modulated signals from receiver system 450 are received by antennas 424, conditioned by receivers 422, demodulated by a demodulator 440, and processed by a RX data processor 442 to extract the reverse link message transmitted by the receiver system 450. Processor 430 then determines which pre-coding matrix to use for determining the beamforming weights and processes the extracted message.

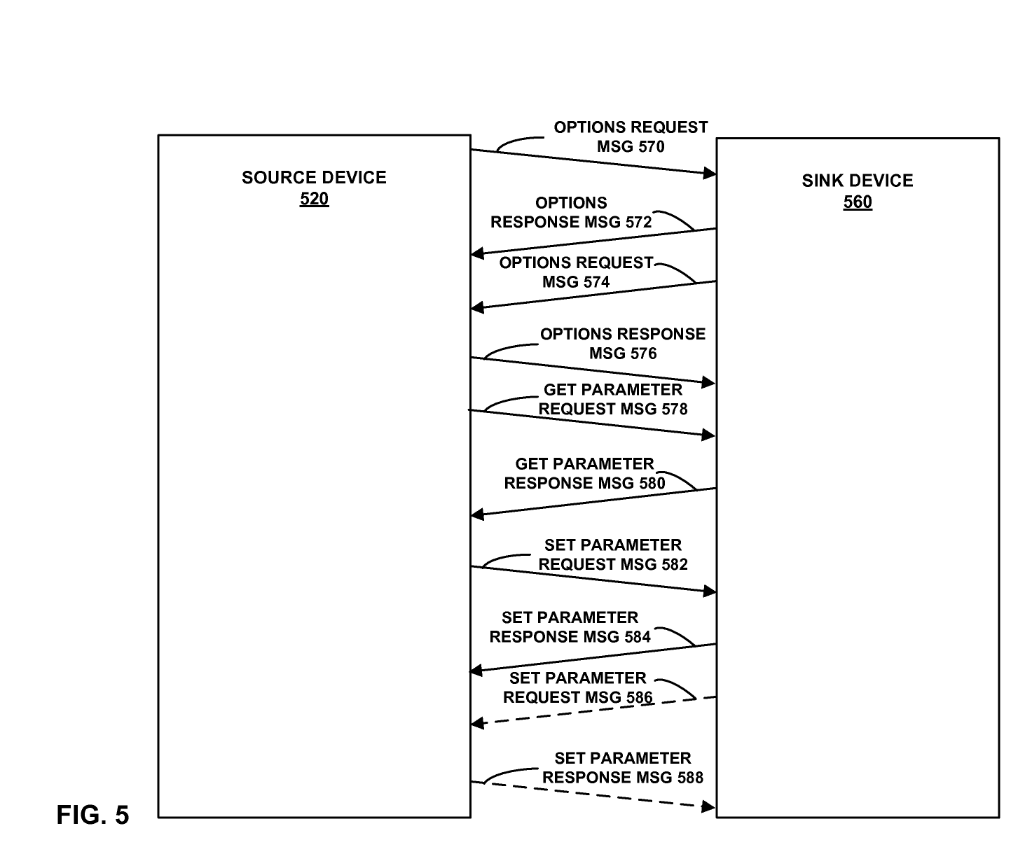

FIG. 5 is a conceptual diagram illustrating an exemplary message transfer sequence for performing MC mode capability negotiations between a source device 520 and a sink device 560. MC mode capability negotiation may occur as part of a larger communication session establishment process between source device 520 and sink device 560. This session may, for example, be established with WFD or TDLS as the underlying connectivity standard. After establishing the WFD or TDLS session, sink device 560 can initiate a TCP connection with source device 520. As part of establishing the TCP connection, a control port running a real time streaming protocol (RTSP) can be established to manage a communication session between source device 520 and sink device 560.

Source device 520 may generally operate in the same manner described above for source device 120 of FIG. 1, and sink device 560 may generally operate in the same manner described above for sink device 160 of FIG. 1. After source device 520 and sink device 560 establish connectivity, source device 520 and sink device 560 may determine the set of parameters to be used for their subsequent communication session and whether the MC mode is supported as part of a capability negotiation exchange.

Source device 520 and sink device 560 may negotiate capabilities through a sequence of messages. The messages may, for example, be real time streaming protocol (RTSP) messages. At any stage of the negotiations, the recipient of an RTSP request message may respond with an RTSP response that includes an RTSP status code other than RTSP OK, in which case, the message exchange might be retried with a different set of parameters or the capability negotiation session may be ended.

Source device 520 can send an RTSP options request message 570 to sink device 560 in order to determine the set of RTSP methods that sink device 560 supports. On receipt of message 570 from source device 520, sink device 560 can respond with an RTSP options response message 572 that lists the RTSP methods supported by sink 560. Message 572 may also include an RTSP OK status code.

After sending message 572 to source device 520, sink device 560 can send an RTSP options request message 574 in order to determine the set of RTSP methods that source device 520 supports. On receipt of message 574 from sink device 560, source device 520 can respond with an RTSP options response message 576 that lists the RTSP methods supported by source device 520. Message 576 can also include an RTSP OK status code.

After sending message 576, source device 520 can send an RTSP get_parameter request message 578 to specify a list of capabilities that are of interest to source device 520. According to the techniques of this disclosure, one of the capabilities requested in message 578 is whether sink device 560 is capable of supporting the MC mode. For example, the MC mode capability parameter may be named “uibc_mc_mode_capa” and RTSP get_parameter request message 578 may be as follows.

S−>C: GET_PARAMETER rtsp://wfd_sink_ip/agent RTSP/1.0

CSeq: 431
Content-Type: text/parameters
Session: 12345678
Content-Length: 15
uibc_mc_mode_capa

Sink device 560 can respond with an RTSP get_parameter response message 580 that may contain an RTSP status code. If the RTSP status code is OK, then message 580 may also include response parameters to those parameters specified in RTSP get_parameter request message 578 that are supported by sink device 560. Sink device 560 can ignore parameters in message 578 that sink device 560 does not support. As an example, sink device 560 may reply with RTSP get_parameter response message 580 to declare its capability of supporting the MC mode, e.g., uibc_mc_mode_capa: yes. The declaration of sink device 20 may follow the ABNF (Augmented Backus-Naur Form) format, as below.

uibc_mc_mode_capa = “uibc_mc_mode_capa:”
SP uibc_mc_mode_capa_option
CRLF
uibc_mc_mode_capa_option = “yes” / “no”

In this case, RTSP get_parameter response message 580 may be as follows.

C−>S: RTSP/1.0 200 OK

CSeq: 431
Content-Length: 20
Content-Type: text/parameters
uibc_mc_mode_capa: yes

Based on message 580, source 520 can determine the optimal set of parameters to be used for the communication session and can send a set_parameter request message 582 to sink device 560. Set_parameter request message 582 can contain the parameter set to be used during the communication session between source device 520 and sink device 560. For example, if both source device 520 and sink device 560 support the MC mode, source device 520 may enable the MC mode for the communication session. In order to enable the MC mode, source device 520 sends an RTSP set_parameter request message 582 to sink device 560 to indicate that the MC mode is enabled and will be used during the communication session, e.g., uibc_mc_mode_capa: yes. RTSP set_parameter request message 582 may be as follows.

S−>C: SET_PARAMETER rtsp://wfd_sink_ip/agent RTSP/1.0

CSeq: 432
Content-length: 20
Content-type: text/parameters
uibc_mc_mode_capa: yes

Upon receipt of message 582, sink device 560 can respond with an RTSP set_parameter response message 584 including an RTSP status code indicating if setting the parameters as specified in message 582 was successful. For example, if sink device 560 indicates its support of the MC mode in the earlier RTSP get_parameter response message 580, sink device 560 acknowledges positively to source device 520 that the MC mode will be used during the communication session, e.g., uibc_mc_mode_capa: yes. RTSP set_parameter response message 584 may be as follows.

C−>S: RTSP/1.0 200 OK

CSeq: 432
Content-Length: 20
Content-Type: text/parameters
uibc_mc_mode_capa: yes

Once the MC mode is enabled for the communication session, sink device 560 activates one of the levels of the MC mode based on trigger information detected from a host system of sink device 560, and signals the activated level of the MC mode to source device 520. In one example, sink device 560 may use an RTSP control message to indicate the activated level of the MC mode to source device 520. In this example, sink device 560 sends an RTSP set_parameter request message 586 to source device 12 including an MC mode level parameter. For example, the MC mode level parameter may be named “uibc_mc_mode.” RTSP set_parameter request message 586 may be as follows.

uibc_mc_mode = “uibc_mc_mode:” SP uibc_mc_mode_instruction
CRLF
uibc_mc_mode_instruction = “no_rules” / “mc-1” / “mc-2” / “mc-3”

Upon activating a specific level of the MC mode based on trigger information detected from the host system, e.g., MC mode level 2 (“mc-2”), sink device 560 sends a signal to source device 520 indicating the activated level of the MC mode, e.g., uibc_mc_mode: mc-2. RTSP set_parameter request message 586 may be as follows.

C−>S: SET_PARAMETER rtsp://wfd_source_ip/agent RTSP/1.0

CSeq: 220
Content-length: 20
Content-type: text/parameters
uibc_mc_mode: mc-2

Upon receipt of message 586, sink device 560 can respond with an RTSP set_parameter response message 588 including an RTSP status code indicating if setting the MC mode level as specified in message 586 was successful. For example, if sink device 560 indicates mc-2 as the activated level of the MC mode in message 586, source device 520 acknowledges positively to sink device 560 that the level 2 of the MC mode will be used during the communication session, e.g., uibc_mc_mode: mc-2. RTSP set_parameter response message 588 may be as follows.

S−>C: RTSP/1.0 200 OK

CSeq: 220
Content-Length: 20
Content-Type: text/parameters
uibc_mc_mode: mc-2

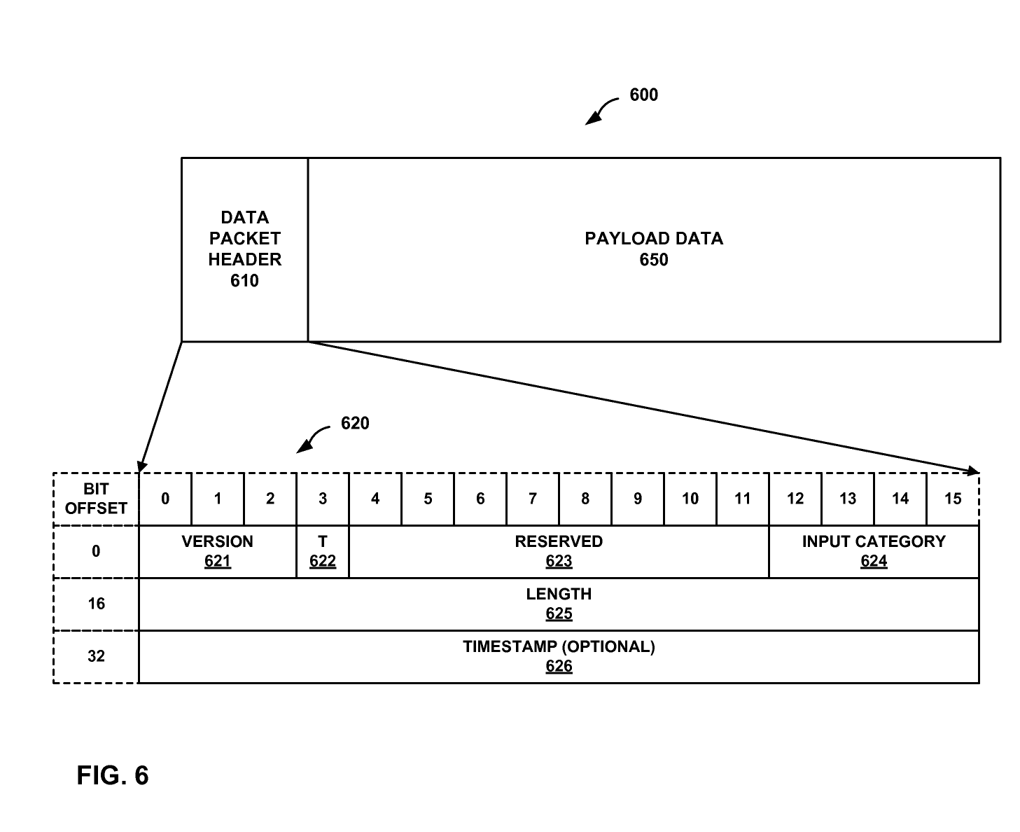

In other examples, sink device 560 and source device 520 may not exchange the RTSP set_parameter messages 586 and 588, as illustrated in FIG. 5, to indicate the activation and use of a specific level of the MC mode. In another example, sink device 560 may instead use the UIBC to signal the activated level of the MC mode to source device 520. The format of the UIBC packet to indicate the activated level of the MC mode is described in more detail with respect to FIG. 6. As mentioned above, the roles of source device and sink device may reverse or change in different sessions. The order of the messages that set up the communication session may, in some cases, define the device that operates as the source and define the device that operates as the sink.

FIG. 6 is a conceptual diagram illustrating an example data packet 600 that may be used for signaling an activated level of the MC mode from a sink device to a source device. Aspects of data packet 600 will be explained with reference to FIG. 1, but the techniques discussed may be applicable to additional types of WD systems. Data packet 600 may include a data packet header 610 followed by payload data 650. Data packet 600 may, for example, be transmitted from sink device 160 to source device 120 in order to signal user input data received at sink device 160, or to signal an MC mode level activated at sink device 160.

The type of data, e.g., user input data or MC mode level data, included in payload data 650 may be identified in data packet header 610. In this way, based on the content of data packet header 610, source device 120 may parse payload data 650 of data packet 600 to identify the user input data or the MC mode level data from sink device 160. As used in this disclosure, the terms “parse” and “parsing” generally refer to the process of analyzing a bitstream to extract data from the bitstream. Extracting data may, for example, include identifying how information in the bitstream is formatted. As will be described in more detail below, data packet header 610 may define one of many possible formats for payload data 650. By parsing data packet header 610, source device 120 can determine how payload data 650 is formatted, and how to parse payload data 650 to extract the user input commands or the MC mode level indication.

In some examples, data packet header 610 may include one or more fields 620 formatted as shown in FIG. 6. The numbers 0-15 and bit offsets 0, 16 and 32 adjacent to fields 620 are intended to identify bit locations within data packet header 610 and are not intended to actually represent information contained within data packet header 610. Data packet header 610 includes version field 621, timestamp flag 622, reserved field 623, input category field 624, length field 625, and optional timestamp field 626. In the example of FIG. 6, version field 621 is a 3-bit field that may indicate the version of a particular communications protocol being implemented by sink device 160. The value in version field 621 may inform source device 120 how to parse the remainder of data packet header 610 as well as how to parse payload data 650.

In the example of FIG. 6, timestamp flag (T) 622 is a 1-bit field that indicates whether or not timestamp field 626 is present in data packet header 610. When present, timestamp field 626 is a 16-bit field containing a timestamp based on multimedia data that was generated by source device 120 and transmitted to sink device 160. The timestamp may, for example, be a sequential value assigned to frames of video by source device 120 prior to the frames being transmitted to sink device 160. Upon parsing data packet header 610 and determining whether timestamp field 626 is present, source device 120 knows whether it needs to process a timestamp included in timestamp field 626. In the example of FIG. 6, reserved field 623 is an 8-bit field reserved for future versions of the particular protocol identified in version field 621.

In the example of FIG. 6, input category field 624 is a 4-bit field to identify an input category for the data contained in payload data 650. For example, sink device 160 may categorize user input data to determine an input category. Categorizing user input data may, for example, be based on the device from which a command is received or based on properties of the command itself. Sink device 160 may also categorize MC mode level instructions to determine an input category. The value of input category field 624, possibly in conjunction with other information of data packet header 610, identifies to source device 120 how payload data 650 is formatted. Based on this formatting, source device 120 can parse payload data 650 to extract the user input commands or the MC mode level indication.

Length field 625 may comprise a 16-bit field to indicate the length of data packet 600. As data packet 600 is parsed by source device 120 in words of 16 bits, data packet 600 can be padded up to an integer number of 16 bits. Based on the length contained in length field 625, source device 120 can identify the end of payload data 650 (i.e. the end of data packet 600) and the beginning of a new, subsequent data packet.

The various sizes of the fields provided in the example of FIG. 6 are merely intended to be explanatory, and it is intended that the fields may be implemented using different numbers of bits than what is shown in FIG. 6. Additionally, it is also contemplated that data packet header 610 may include fewer than all the fields discussed above or may use additional fields not discussed above. Indeed, the techniques of this disclosure may be flexible, in terms of the actual format used for the various data fields of the packets.

Input category 624 may identify one of many possible input categories. One such input category may be a generic input format to indicate that the user input data of payload data 650 is formatted using generic information elements defined in a protocol being executed by both source device 120 and sink device 160. A generic input format may utilize generic information elements that allow for a user of sink device 160 to interact with source device 120 at the application level.

Another such input category may be a human interface device command (HIDC) input format to indicate that the user input data of payload data 650 is formatted based on the type of input device used to receive the input data. Examples of types of devices include a keyboard, mouse, touch input device, joystick, camera, gesture capturing device (such as a camera-based input device), and remote control. Other types of input categories that might be identified in input category field 624 include a forwarding input format to indicate user data in payload data 650 did not originate at sink device 160, or an operating system specific format, and a voice command format to indicate payload data 650 includes a voice command.

According to the techniques of this disclosure, a further input category may be an instruction input format to indicate that the user input data of payload data 650 is formatted using instruction information elements defined in a protocol being executed by both source device 120 and sink device 160. An instruction input format may utilize an instruction information element that indicates the activated level of the MC mode at sink device 160.

The input categories that may be identified in input category field 624 are included in Table 2, below. Input category 624, in the example of FIG. 6, is 4 bits and sixteen different input categories could possibly be identified. Table 2 defines three input categories and holds the remaining input categories as reserved.

TABLE 2

| Input | | |
|---|---|---|
| Category | Category | Notes |
| 0 | Generic | User input data are formatted using generic |
| | | information elements. |
| 1 | HIDC | User input data are formatted using HIDC |
| | | information elements. |
| 2 | Instruction | Instructions are formatted using instruction |
| | | information elements. |
| 3-15 | Reserved | |

If, for example, input category field 624 of data packet header 610 indicates an instruction input is present in payload data 650, then payload data 650 can have an instruction input format. Source device 120 can thus parse payload data 650 according to the instruction input format. An instruction input event within payload data 650 may include an input event header. Table 3, below, defines the fields of an instruction input event (IE) header for an MC mode level instruction IE.

TABLE 3

| | Size | |
|---|---|---|
| Field | (Octet) | Value |
| Instruction IE ID | 1 | Instruction type |
| Length | 2 | Length of the following fields in |
| | | octets |
| MC Mode Level Code | 1 | Indicates the MC Mode level |

The instruction IE identification (ID) field identifies an instruction type, e.g., an MC mode instruction type. The instruction IE ID field may, for example, be one octet in length and may include an identification selected from Table 4 below. If, as in this example, the instruction IE ID field is 8 bits, then 256 different types of instructions (identified 0-255) may be identifiable, although not all 256 identifications necessarily need an associated instruction type. Some of the 256 may be reserved for future use. In Table 4, for instance, only instruction IE ID 0 is defined as indicating the MC mode instruction type. Instruction IE IDs 1-255 do not have associated instruction types but could be assigned instruction types in the future.

In this example, where the instruction IE ID indicates the MC mode instruction type, the length field in the instruction IE header identifies the length of the MC Mode Level Code field while the MC Mode Level Code field includes the information elements that describe the instruction. The formatting of the MC Mode Level Code field is known from the MC mode instruction type in the instruction IE ID field. Thus, source device 120 may parse the contents of the MC Mode Level Code field based on the MC mode instruction type identified in the instruction IE ID field. Based on the length field of the instruction IE header, source device 120 can determine the end of the instruction IE in payload data 650.

Table 4 provides an example of instruction types, each with a corresponding instruction IE ID that can be used for identifying the instruction type. As discussed above, in this example, only instruction IE ID 0 is defined as indicating the MC mode instruction type. Instruction IE IDs 1-255 in Table 4 do not have associated instruction types but could be assigned instruction types in the future.

TABLE 4

| Instruction IE ID | Notes |
|---|---|
| 0 | Minimal Cognitive Mode |
| 1-255 | Reserved |

The MC Mode Level Code field associated with the MC mode instruction type may have a specific format. The MC Mode Level Code field may include the information elements identified in Table 5 below to indicate one of the levels of the MC mode activated at sink device 160.

TABLE 5

| MC Mode Level | |
|---|---|
| Code | Notes |
| 0 | No MC Mode rule restriction |
| 1 | MC-1 |
| 2 | MC-2 |
| 3 | MC-3 |
| 4-255 | Reserved |

For example, MC mode level code 0 indicates that no MC mode level is activated at sink device 160. In this case, no rules are applied to modify operation of source device 120. According to Table 5, MC mode level code 1, 2 and 3 respectively indicate that MC mode levels MC-1, MC-2, and MC-3 are activated at sink device 160. Based on the indication of the activated MC mode level, the techniques of this disclosure may modify the operation of source device 120 based on rules configured for the activated level.

As an example, at the MC-1 level, the associated rules may allow normal processing and transmission of telephone calls and general A/V content to sink device 160, but restrict the operation of source device 120 to only render audio-based text messages. At the MC-2 level, the associated rules may restrict the operation of source device 120 to only render audio-based telephone calls and general A/V content, and the not render any text messages. In addition, the rules associated with the MC-2 level may restrict the user interaction at sink device 160 to be voice command only. At the MC-3 level, the associated rules may restrict the operation of source device 120 to not render any telephone calls, text messages, or general A/V content for transmission to sink device 160. In addition, the rules associated with the MC-3 level may not allow any user interaction at sink device 160. In other examples, different rules may be configured for one or more of MC mode levels MC-1, MC-2, and MC-3.

The MC Mode Level Code field may, for example, be one octet in length and may include an identification selected from Table 5. If, as in this example, the MC Mode Level Code field is 8 bits, then 256 different MC mode levels (identified 0-255) may be identifiable, although not all 256 identifications necessarily need an associated MC mode level. Some of the 256 may be reserved for future use. In Table 5, for instance, only MC mode level codes 0-3 are defined as indicating different MC mode levels. MC mode level codes 4-255 do not have associated MC mode levels but could be assigned levels in the future.

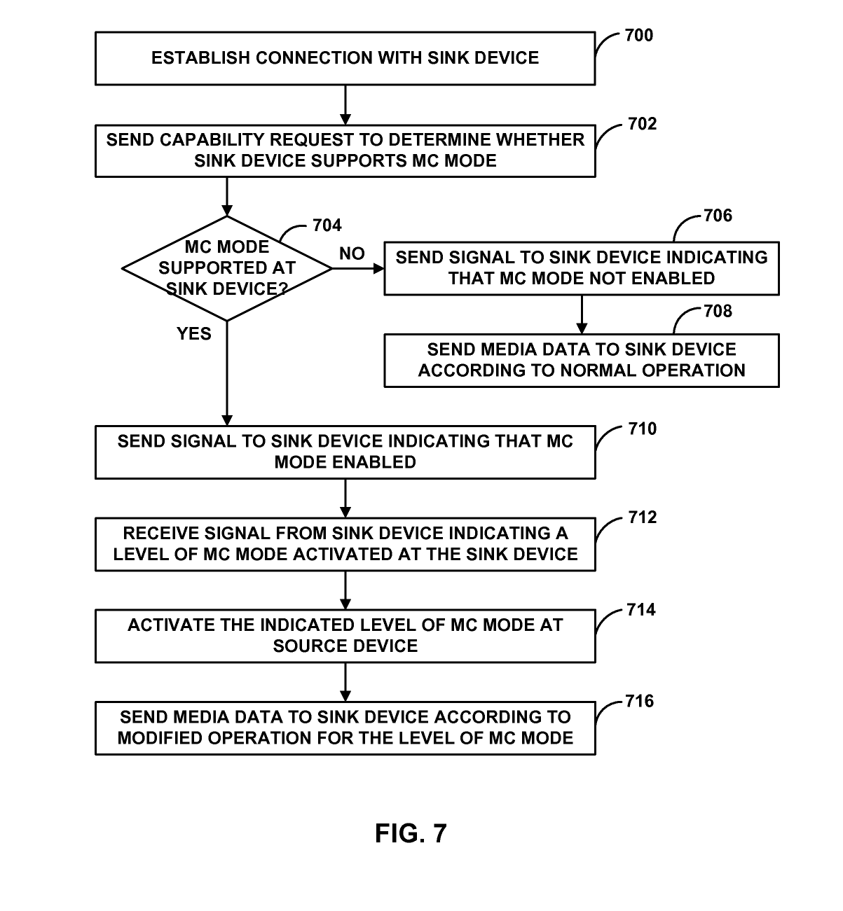

FIG. 7 is a flowchart illustrating an exemplary operation of a source device capable of supporting the MC mode. The MC mode operation will be described with respect to source device 220 from FIG. 2. In other examples, the illustrated operation may be performed by other source devices, including source device 120 from FIG. 1.

Source device 220 first establishes a connection with a sink device (700). For example, source device 220 may advertise its media data to one or more near-by sink devices, or a user of source device 220 may manually configure the connection to a specific sink device. Once the connection is established, source device 220 exchanges capability negotiation messages with the sink device to set up parameters of a communication session over the connection. For example, the capability negotiation messages may comprise RTSP messages. According to the techniques of this disclosure, source device 220 sends a capability request, e.g., an RTSP get_parameter request message, to the sink device to determine whether the sink device support the MC mode (702).

If the sink device does not support the MC mode, e.g., as indicated in an RTSP get_parameter response message, (NO branch of 704), source device 220 sends a signal, e.g., an RTSP set_parameter request message, to the sink device indicating that the MC mode is not enabled for the communication session (706). Source device 220 may then render and send media data to the sink device according to normal operation of processor 231 (708).

If the sink device does not support the MC mode, e.g., as indicated in an RTSP get_parameter response message, (YES branch of 704), source device 220 sends a signal, e.g., an RTSP set_parameter request message, to the sink device indicating that the MC mode is enabled for the communication session (710). Once the MC mode has been enabled, source device 220 may receive a signal from the sink device indicating a level of the MC mode that has been activated at the sink device (712). For example, the sink device may have detected trigger information from its host system and, based on the trigger information, activated one of the levels of the MC mode, e.g., MC-1, MC-2 or MC-3, to modify the media data received at the sink device. Source device 220 may receive the indicated level of the MC mode from one of a control message, e.g., an RTSP set_parameter request message, or a data packet, e.g., a UIBC packet with an MC mode instruction type.

Upon receipt of the indicated MC mode level, MC mode unit 240 within source device 220 activates the indicated level of the MC mode at source device 220 (714). MC mode unit 240 then directs processor 231 to modify the type of A/V data, e.g., telephone calls, text messages, and audio and/or video content, being processed by source device 220 according to the rules associated with the activated level of the MC mode. Source device 220 may then render and send media data to the sink device according to the modified operation of processor 231 for the activated level of the MC mode (716).

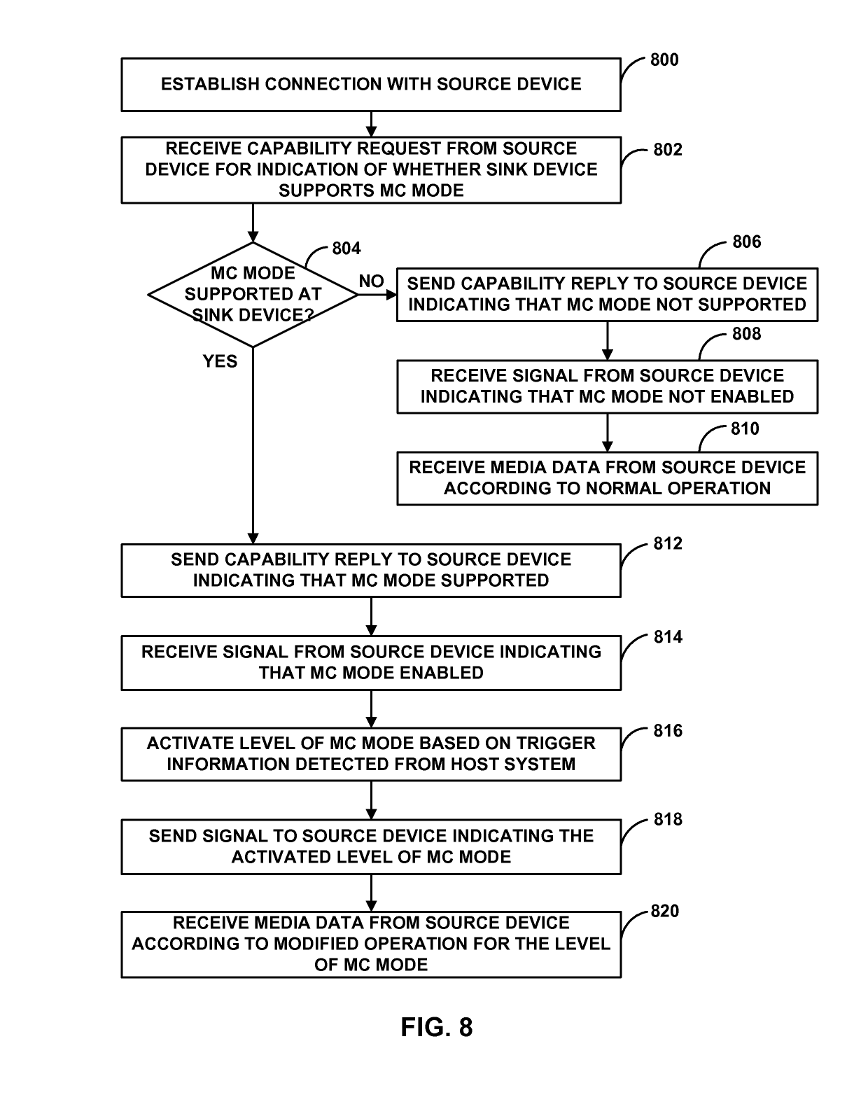

FIG. 8 is a flowchart illustrating an exemplary operation of a sink device capable of supporting the MC mode. The MC mode operation will be described with respect to sink device 360 from FIG. 3. In other examples, the illustrated operation may be performed by other sink devices, including sink device 160 from FIG. 1.

Sink device 360 first establishes a connection with a source device (800). For example, sink device 360 may respond to an advertisement of media data from a near-by source device 220, or a user of sink device 360 may manually configure the connection to a specific source device. Once the connection is established, sink device 360 exchanges capability negotiation messages with the source device to set up parameters of a communication session over the connection. For example, the capability negotiation messages may comprise RTSP messages. According to the techniques of this disclosure, sink device 360 receives a capability request, e.g., an RTSP get_parameter request message, from the source device for an indication of whether sink device 360 support the MC mode (802).

If sink device 360 does not support the MC mode (NO branch of 804), sink device 360 sends a capability reply, e.g., an RTSP get_parameter response message, to the source device indicated that the MC mode is not supported (806). Sink device 360 then receives a signal, e.g., an RTSP set_parameter request message, from the source device indicating that the MC mode is not enabled for the communication session (708). Sink device 360 may then receive media data from the source device according to normal operation of the source device (810).

If sink device 360 does not support the MC mode (YES branch of 804), sink device 360 sends a capability reply, e.g., an RTSP get_parameter response message, to the source device indicated that the MC mode is supported (812). Sink device 360 then receives a signal, e.g., an RTSP set_parameter request message, from the source device indicating that the MC mode is enabled for the communication session (814). Once the MC mode has been enabled, sink device 360 may activate a level of the MC mode based on trigger information detected from host system 300 (816). For example, MC mode unit 378 within sink device 360 may detect trigger information received from sensors 312 of host system 300 and, based on the trigger information, activate one of the levels of the MC mode, e.g., MC-1, MC-2 or MC-3.

Sink device 360 then sends a signal to the source device indicating the activated level of the MC mode (818). Sink device 360 may send the activated level of the MC mode using one of a control message, e.g., an RTSP set_parameter request message, or a data packet, e.g., a UIBC packet with an MC mode instruction type. Sink device 360 sends the activated level of the MC mode to the source device to modify the type of A/V data, e.g., telephone calls, text messages, and audio and/or video content, received at sink device 360 according to the rules associated with the activated level of the MC mode. Sink device 360 then receives media data from the source device according to the modified operation of the source device for the activated level of the MC mode (820). In addition, MC mode unit 378 modifies the operation of user input interface 376 to only accept the types of user interaction, e.g., voice and touch commands, voice commands only, or no commands, allowed by the rules associated with the activated level of the MC mode.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. In some examples, computer-readable media may comprise non-transitory computer-readable media. Data storage media may be any available media that can be accessed by one or more computers or one or more processors to retrieve instructions, code and/or data structures for implementation of the techniques described in this disclosure.

By way of example, and not limitation, such computer-readable media can comprise non-transitory media such as RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention have been described. These and other embodiments are within the scope of the following claims.

What is claimed is:

1. A method comprising:
establishing, with a source device, a connection with at least one sink device, wherein the source device and the sink device support a Minimal Cognitive (MC) mode that includes one or more levels;
receiving, with the source device, a signal from the sink device indicating one of the levels of the MC mode, wherein the indicated level of the MC mode is activated at the sink device based on trigger information detected from a host system of the sink device;
activating the indicated level of the MC mode at the source device; and
sending media data to the sink device according to a modified operation of the source device for the activated level of the MC mode.

2. The method of claim 1, further comprising:
determining whether the sink device supports the MC mode; and
if the sink device supports the MC mode, sending a signal to the sink device indicating that the MC mode is enabled.

3. The method of claim 2, further comprising:
if the sink device does not support the MC mode, sending a signal to the sink device indicating that the MC mode is not enabled; and
sending media data to the sink device according to a normal operation of the source device.

4. The method of claim 1, wherein activating the indicated level of the MC mode further comprises modifying operation of the source device based on rules configured for the activated level of the MC mode.

5. The method of claim 1, wherein activating the indicated level of the MC mode further comprises modifying operation of one or more of a telephony application, a text messaging application, and media data rendering at the source device.

6. The method of claim 1, wherein the trigger information for the indicated level of the MC mode includes one or more of environmental conditions, user behavior, and user inputs detected by the sink device from the host system.

7. The method of claim 1, wherein receiving the signal from the sink device indicating one of the levels of the MC mode comprises receiving a Real Time Streaming Protocol (RTSP) control message with a parameter defined to indicate the activated level of the MC mode at the sink device.

8. The method of claim 1, wherein receiving the signal from the sink device indicating one of the levels of the MC mode comprises receiving a User Interaction Back Channel (UIBC) packet for an input category defined to indicate the activated level of the MC mode at the sink device.

9. The method of claim 1, wherein the source device comprises a wireless communication device and the sink device comprises a media head unit within a motor vehicle host system.

10. A method comprising:
establishing, with a sink device, a connection with a source device, wherein the source device and the sink device support a Minimal Cognitive (MC) mode that includes one or more levels;
activating one of the levels of the MC mode at the sink device based on trigger information detected from a host system of the sink device;
sending a signal to the source device indicating the activated level of the MC mode at the sink device; and
receiving media data at the sink device according to a modified operation of the source device for the activated level of the MC mode.

11. The method of claim 10, further comprising:
receiving a request from the source device for an indication of whether the sink device supports the MC mode;
if the sink device supports the MC mode, sending a reply to the source device indicating that the sink device supports the MC mode; and
receiving a signal from the source device indicating that the MC mode is enabled.

12. The method of claim 11, further comprising:
if the sink device does not support the MC mode, sending a reply to the source device indicating that he sink device does not support the MC mode;
receiving a signal from the source device indicating that the MC mode is not enabled; and
receiving media data from the source device according to a normal operation of the source device.

13. The method of claim 10, wherein activating one of the levels of the MC mode further comprises modifying operation of the sink device based on rules configured for the activated level of the MC mode.

14. The method of claim 10, wherein activating one of the levels of the MC mode further comprises modifying operation of a user input interface at the sink device.

15. The method of claim 10, further comprising detecting the trigger information from one or more sensors within the host system of the sink device, wherein the trigger information for the activated level of the MC mode includes one or more of environmental conditions, user behavior, and user inputs.

16. The method of claim 10, wherein sending the signal to the source device indicating the activated level of the MC mode comprises sending a Real Time Streaming Protocol (RTSP) control message with a parameter defined to indicate the activated level of the MC mode at the sink device.

17. The method of claim 10, wherein sending the signal to the source device indicating the activated level of the MC mode comprises sending a User Interaction Back Channel (UIBC) packet for an input category defined to indicate the activated level of the MC mode at the sink device.

18. The method of claim 10, wherein the sink device comprises a media head unit within a motor vehicle host system and the source device comprises a wireless communication device.

19. A source device comprising:
a memory that stores media data; and
a processor configured to establish a connection with at least one sink device, wherein the source device and the sink device support a Minimal Cognitive (MC) mode that includes one or more levels, receive a signal from the sink device indicating one of the levels of the MC mode, wherein the indicated level of the MC mode is activated at the sink device based on trigger information detected from a host system of the sink device, activate the indicated level of the MC mode at the source device, and send media data to the sink device according to a modified operation of the source device for the activated level of the MC mode.

20. The source device of claim 19, wherein the processor determines whether the sink device supports the MC mode, and, if the sink device supports the MC mode, the processor sends a signal to the sink device indicating that the MC mode is enabled.

21. The source device of claim 20, wherein, if the sink device does not support the MC mode, the processor sends a signal to the sink device indicating that the MC mode is not enabled, and sends media data to the sink device according to a normal operation of the source device.

22. The source device of claim 19, wherein the processor modifies operation of the source device based on rules configured for the activated level of the MC mode.

23. The source device of claim 19, wherein the processor modifies operation of one or more of a telephony application, a text messaging application, and media data rendering at the source device.

24. The source device of claim 19, wherein the trigger information for the indicated level of the MC mode includes one or more of environmental conditions, user behavior, and user inputs detected by the sink device from the host system.

25. The source device of claim 19, wherein the processor receives a Real Time Streaming Protocol (RTSP) control message with a parameter defined to indicate the activated level of the MC mode at the sink device.

26. The source device of claim 19, wherein the processor receives a User Interaction Back Channel (UIBC) packet for an input category defined to indicate the activated level of the MC mode at the sink device.

27. The source device of claim 19, wherein the source device comprises a wireless communication device and the sink device comprises a media head unit within a motor vehicle host system.

28. A sink device comprising:
a memory that stores media data; and
a processor configured to establish a connection with a source device, wherein the source device and the sink device support a Minimal Cognitive (MC) mode that includes one or more levels, activate one of the levels of the MC mode at the sink device based on trigger information detected from a host system of the sink device, send a signal to the source device indicating the activated level of the MC mode at the sink device, and receive media data at the sink device according to a modified operation of the source device for the activated level of the MC mode.

29. The sink device of claim 28, wherein the processor receives a request from the source device for an indication of whether the sink device supports the MC mode, if the sink device supports the MC mode, the processor sends a reply to the source device indicating that the sink device supports the MC mode, and receives a signal from the source device indicating that the MC mode is enabled.

30. The sink device of claim 29, wherein, if the sink device does not support the MC mode, the processor sends a reply to the source device indicating that he sink device does not support the MC mode, receives a signal from the source device indicating that the MC mode is not enabled, and receives media data from the source device according to a normal operation of the source device.

31. The sink device of claim 28, wherein the processor modifies operation of the sink device based on rules configured for the activated level of the MC mode.

32. The sink device of claim 28, wherein the processor modifies operation of a user input interface at the sink device.

33. The sink device of claim 28, wherein the processor detects the trigger information from one or more sensors within the host system of the sink device, wherein the trigger information for the activated level of the MC mode includes one or more of environmental conditions, user behavior, and user inputs.

34. The sink device of claim 28, wherein the processor sends to the source device a Real Time Streaming Protocol (RTSP) control message with a parameter defined to indicate the activated level of the MC mode at the sink device.

35. The sink device of claim 28, wherein the processor sends to the source device a User Interaction Back Channel (UIBC) packet for an input category defined to indicate the activated level of the MC mode at the sink device.

36. The sink device of claim 28, wherein the sink device comprises a media head unit within a motor vehicle host system and the source device comprises a wireless communication device.

37. A source device comprising:
means for establishing a connection with at least one sink device, wherein the source device and the sink device support a Minimal Cognitive (MC) mode that includes one or more levels;
means for receiving a signal from the sink device indicating one of the levels of the MC mode, wherein the indicated level of the MC mode is activated at the sink device based on trigger information detected from a host system of the sink device;
means for activating the indicated level of the MC mode at the source device; and
means for sending media data to the sink device according to a modified operation of the source device for the activated level of the MC mode.

38. The source device of claim 37, further comprising:
means for determining whether the sink device supports the MC mode; and
if the sink device supports the MC mode, means for sending a signal to the sink device indicating that the MC mode is enabled.

39. The source device of claim 37, further comprising means for modifying operation of the source device based on rules configured for the activated level of the MC mode.

40. The source device of claim 37, further comprising means for modifying operation of one or more of a telephony application, a text messaging application, and media data rendering at the source device.

41. The source device of claim 37, wherein the trigger information for the indicated level of the MC mode includes one or more of environmental conditions, user behavior, and user inputs detected by the sink device from the host system.

42. A sink device comprising:
means for establishing a connection with a source device, wherein the source device and the sink device support a Minimal Cognitive (MC) mode that includes one or more levels;
means for activating one of the levels of the MC mode at the sink device based on trigger information detected from a host system of the sink device;
means for sending a signal to the source device indicating the activated level of the MC mode at the sink device; and
means for receiving media data at the sink device according to a modified operation of the source device for the activated level of the MC mode.

43. The sink device of claim 42, further comprising:
means for receiving a request from the source device for an indication of whether the sink device supports the MC mode;
if the sink device supports the MC mode, means for sending a reply to the source device indicating that the sink device supports the MC mode; and
means for receiving a signal from the source device indicating that the MC mode is enabled.

44. The sink device of claim 42, further comprising means for modifying operation of the sink device based on rules configured for the activated level of the MC mode.

45. The sink device of claim 42, further comprising means for modifying operation of a user input interface at the sink device.

46. The sink device of claim 42, further comprising means for detecting the trigger information from one or more sensors within the host system of the sink device, wherein the trigger information for the activated level of the MC mode includes one or more of environmental conditions, user behavior, and user inputs.

47. A computer-readable medium comprising instructions that when executed in a source device cause a programmable processor to:
establish a connection with at least one sink device, wherein the source device and the sink device support a Minimal Cognitive (MC) mode that includes one or more levels;
receive a signal from the sink device indicating one of the levels of the MC mode, wherein the indicated level of the MC mode is activated at the sink device based on trigger information detected from a host system of the sink device;
activate the indicated level of the MC mode at the source device; and
send media data to the sink device according to a modified operation of the source device for the activated level of the MC mode.

48. A computer-readable medium comprising instructions that when executed in a sink device cause a programmable processor to:
establish a connection with the source device, wherein the source device and the sink device support a Minimal Cognitive (MC) mode that includes one or more levels;
activate one of the levels of the MC mode at the sink device based on trigger information detected from a host system of the sink device;
send a signal to the source device indicating the activated level of the MC mode at the sink device; and
receive media data from the source device according to a modified operation of the source device for the activated level of the MC mode.
